(19) United States
(12) Patent Application Publication
(10) Pub. No.: US 2010/0287509 A1
(43) Pub. Date: Nov. 11, 2010

(54) Efficient User Interface and Method of Making Selections for Electronic Devices

(76) Inventor: David George Sempek, Omaha, NE (US)

Correspondence Address: David Sempek, 101 S 55th St., Omaha, NE, 68132, US

(21) Appl. No.: 12/772,222

(22) Filed: May 2, 2010

Related U.S. Application Data
(60) Provisional application No. 61/175,675, filed on May 5, 2009.

(51) Int. Cl. G06F 3/048

(52) U.S. Cl. 715/841; 715/845

(57) ABSTRACT

In electronics devices, a user interface and method for presenting and selecting user selectable items with a limited number of inputs is described. In one embodiment, a portable media player, three buttons are utilized as hint selectors and choice items are associated with hints selectors and displayed with these hints. When a hint selector is actuated, choice items not associated with the hint selector are eliminated from the choice items list and the remaining choice items are again associated with the hint selectors for display to the user. This process is repeated until a single choice items is selected by the hint selector. In one embodiment this method requires a maximum of Log_{b}(N) user inputs to make the selection (where N is the cardinality of choice items and b is the cardinality of hint selectors). In one of the described embodiments a method is given for calculating a first order hints and subsequent order hints to display with the choice items. In one of the described embodiments a method is given for grouping large lists and applying this hint method to facilitate presentation to the user.

### CROSS REFERENCE TO RELATED APPLICATIONS

The present application claims the benefit under 35 U.S.C. § 119 of U.S. Provisional Application Ser. No. 61/175,675 filed May 5, 2009.

### BACKGROUND

Modern electronic devices have become increasingly more powerful while also shrinking in size. These changes have brought unprecedented utility to users but present a problem to the designer in trying to provide useful, efficient ways to provide access to all the functions available to these devices. Many of these devices, which include handheld music players, set top boxes, digital video recorders (DVR), mobile phones, automobile dash displays, etc., can provide access to large repositories of music, movies, internet, databases, and other features. At the same time the user may only have a small number of input options to access these features. Input options may include a 4-way rocker switch, 10-key pad, remote controllers, game controllers, motion or accelerometer based inputs, or other such input as found on these types of devices.

When trying to pick from a large number of choice items (all or a subset of user selectable items) from a device with limited input, like music from an mp3 player or video library on a TV, many devices attempt to have you use arrow keys to select letters from a virtual keyboard or scroll (with arrows or jog shuttle) up and down through a long list of items. Other methods assign multiple characters to keys and use a combination of multiple key presses to cycle through the assigned characters followed by a pause to indicate your selection, this method commonly used on mobile phones and remote controls can be seen on most phones where a,b, c, and 2 are associated with 2 on your phone. Other methods involve using a joystick or track ball, or mouse to move an on screen indicator to point to characters on a virtual keyboard or choice items for selection. All of the existing methods are very tedious and slow, often involving precise timing or multiple simultaneous key strokes, especially if the list of items is large.

Consequently, it is desirable to provide a system and method that allows efficient selection of options and input into these devices.

### SUMMARY OF THE INVENTION

Accordingly, the present invention is directed toward allowing efficient selection of items in these types of devices. The invention relates to a system that has a display and a plurality of inputs, at least two of the inputs are assigned as hint selectors, the choice items which the user is to choose from are then assigned to the hint selectors, assigning multiple items to each selector as necessary, and the hint selector is associated with the choice item via the display. The user then uses the sequence selector to indicate which group his choice item is associated with, if there is more than one choice item associated with the hint selector indicated by the user, all the choice items are redistributed to the sequence selectors and presented for user selection again. In this way the user winnows the selections until the sequence selector refers to only a single choice item which can then be selected.

Associating the hint selectors with the choice items on an display can be accomplished in many ways, some of the preferred methods are: assigning a color to the hint selectors and coloring the background or foreground of the choice item with the corresponding color, assign arrows to hint selectors and display the arrow with the corresponding choice item, assign text, number or other symbol with each hint selector and display the corresponding character or character/number/symbol with each choice item, assigned icons or shaded/colored dots with each hint selector and display the icons or dots with the corresponding choice item.

When the cardinality of choice items exceeds that of the hint selectors then subsequent hint selector assignments can be determined in advance so that a sequence of hint selectors can be displayed with the choice item. This sequence, when followed, will select the corresponding choice item or progress toward selection of the choice item and facilitates rapid convergence on the user's selection because they can enter the sequence without having to pause between inputs to see the next hint selector assignment.

When the cardinality of choice items exceeds the capacity of the display the choice items may be grouped by some logic dictated by the items where the cardinality of the groups is less than or equal to the capacity of the display. These groups become the temporary choice items and the previous method is followed. In this manner all references to a specific choice item apply to grouping and temporary choice items so the same methods and procedures apply. Grouping is performed as many times as required until the actual choice items may be conveyed. This is easiest to understand by looking at one of the preferred embodiments where the choice items are a large list of textual labels and the output conveyance is a display screen. The first grouping would be comprised of the first character of each choice item. When one of the groups is selected the first character can be displayed in a progress area on the display screen and the second character would be grouped and displayed. Continuing in this manner will eventually result in a subset of choice items that can be displayed on the screen and selected as previously described. Another of many possible grouping schemes would be to display ranges such as ‘a-e’, ‘f-m’, ‘n-s’, ‘t-z’.

This invention reduces the number of inputs required from the user because each user input eliminates all the choices associated with other hint selectors.

In another preferred embodiment the method of conveying information to the user is a display screen and the inputs are keys in a four way rocker configuration as found on many cell phones and remote controls. The choice items may be a list of menu options or list of music or videos, etc. Three of the four way keys are used as hint selectors (for example left, up, and right) while the fourth key (down) is used to undo the last selection or return to a preset menu list. Hint selector assignment, or assignment sequence can be indicated on the display for each choice item by one or more of the previously discussed methods e.g. coloring background or foreground, arrows, colored dots, icons, text, numbers, or symbols.

Another preferred embodiment would be as described in the previous paragraph except the inputs are the 0-9 number keys as found on phones and remote controls. Numbers 1 through 9 could be utilized as hint selectors and 0 could be used to undo the last selection or return to a preset menu list.

It is to be understood that both the foregoing general description and the following detailed description are exemplary and explanatory only and are not restrictive of the invention. The accompanying drawings, which are incorporated in and constitute a part of the specification, illustrate an embodiment of the invention and together with the general description, serve to explain the principles of the invention. The word “exemplary” is used herein to mean serving as an example, instance, or illustration. Any aspect or design described herein as “exemplary” is not necessarily to be construed as preferred or advantageous over other aspects or design.

### BRIEF DESCRIPTION OF THE DRAWINGS

The advantages of the present invention may be better understood by those skilled in the art by reference to the accompanying figures in which:

FIG. 1 shows an exemplary portable media player 100 displaying hints, hint selectors, and choice items in accordance with an embodiment of the invention.

FIG. 2 shows a flowchart illustrating a particular process for selecting a choice item from a list of choice items in accordance with an embodiment of the invention.

FIG. 3 shows an exemplary portable media player 100 displaying the method of grouping based on textual choice items in accordance with an embodiment of the invention.

FIG. 4 shows exemplary equations which can be used to associate hint selectors with choice items as well as subsequent order hint selection equations in a particular embodiment of the invention.

FIG. 5 (5A, 5B, 5C, 5D) shows exemplary grouping method based on textual choice item in greater detail, showing each step after input selector actuations in accordance with an embodiment of the invention.

FIG. 6 (6A, 6B) shows exemplary application of the invention applied to a scrollable list.

### DETAILED DESCRIPTION OF THE INVENTION

Reference will now be made in detail to a preferred embodiment of the invention. An example of the preferred embodiment is illustrated in the accompanying drawings. While the invention will be described in conjunction with a preferred embodiment, it will be understood that it is not intended to limit the invention to one preferred embodiment. To the contrary, it is intended to cover alternatives, modifications, and equivalents as may be included within the spirit and scope of the invention as defined by the appended claims.

Recent technological advancements have brought about massive inexpensive storage and inexpensive devices capable of accessing this storage (be it though wired or wireless connectivity) and delivering the content to users in myriad ways. Both individual users and companies have found it cost effective to convert all of their media to digital storage and access it though a convenient device. A portable media player is one such device and can easily provide access to libraries of thousands, potentially millions, of media files. The task of providing an interface where the user can indicate his desired selection is difficult generally exacerbated physical limitations of the device. The following described embodiment takes the form of a portable media player.

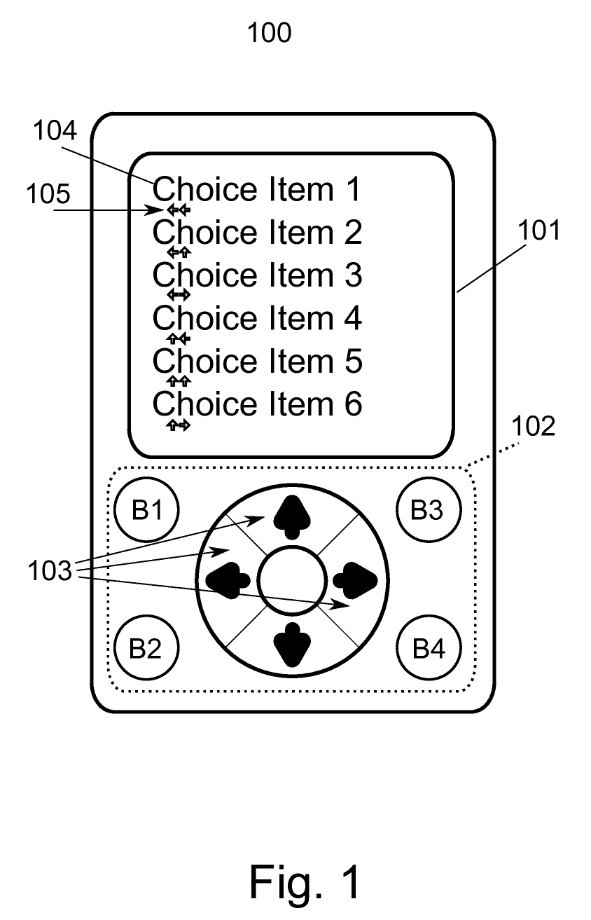

In a particular embodiment FIG. 1 shows an exemplary portable media player 100. The portable media player 100 has an output conveyance in the form of a display screen 101, a plurality of inputs to the device in the form of eight input buttons 102. Four of the buttons 102 are arranged in a 4-way rocker configuration. In this particular embodiment we assign a subset of the input buttons, namely the left, up, and right buttons, to be used as hint selectors 103 note that there must always be a plurality of hint selectors. When the portable media player 100 displays a list of choice items 104 on the screen it also displays the associated hint(s) 105. In this example the hint(s) 105 are displayed as an arrow which corresponds to our hint selectors 103. There are many ways to associate hint(s) 105 to hint selectors 103 and choice items 104. Some possibilities include assigning colors, icons, numbers, characters, or symbols to hint selectors 103 and displaying colored background, colored foreground, icons, numbers, characters, or symbols as hint(s) 105. Any single or combination of these or other methods may be utilized and it is best to leave the decision to persons of ordinary skill in the art to make the optimal decision based on each specific case. Note that the hint selectors 103 needn't be dedicated to function as hint selectors but are optioned this way when the portable media player 100 displays choice items 104 on the screen 101.

The number and locations of hint(s) 105 may vary based on a specific implementation. In some circumstances it may be desirable to only display the first order hint or some subset of the hint sequence instead of the entire hint sequence.

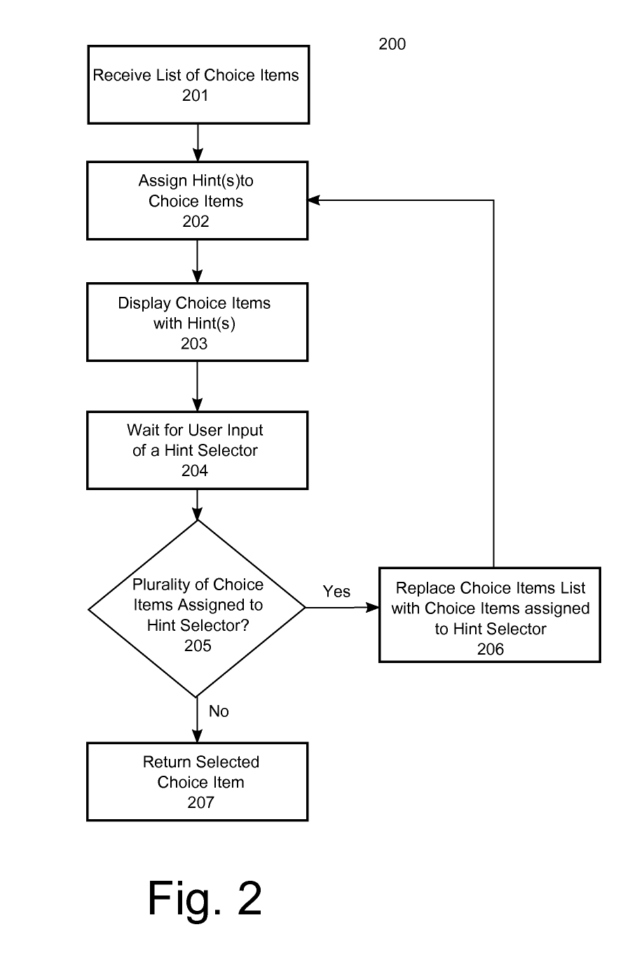

FIG. 2 contains a flow chart 200 illustrating one method for practicing the present invention in a particular embodiment to select a single choice item 104 from a list of choice items. Accordingly numerous steps may be added to, or taken away from the flow chart without departing from the scope of the invention. Additionally considerations in implementing the method described by the flow chart may also dictate changes in the selection and order of steps.

Initially the device 100 needs to create a list of items to present to the user for selection. This list may come from internal storage (RAM, ROM, flash, hard drive, or some such other storage) or from an external wired or wireless source. This list may comprise menu options or commands, a list of media for the user to select to perform an operation(s) on, hypertext links, or other such list that the device 100 presents to the user for selection. Generally selecting an item from a list involves scrolling a cursor though the potential candidates followed by pressing an ‘enter’ or ‘select’ key thereby selecting the item associated with the cursor or using a mouse or other pointing device to point to the selection and pressing an ‘enter’ or ‘select’ key. This method becomes untenable for large lists. In one embodiment selecting an element takes the following steps: a list of items is received step 201 becoming our choice items 104, hint(s) 105 are assigned to choice items step 202, the choice items are displayed with the hint(s) on the screen 101 step 203, user actuation of one of the hint selectors 103 is received step 204. If there is only one choice item associated with the actuated hint selector then we return the singular choice item as the selected item (205, 207), otherwise we take all the choice items associated with the actuated hint selector and set this subset as our new list of choice items (205, 206) and start back at 202 to assign hint selectors.

Care should be taken in associating hint selectors 103 to choice items 104. Although random assignment would eventually result in a selection as long as there is always at least one choice item associated with each hint selector, random assignment is rarely likely to be optimal. Clever association of hint selectors to choice items will result in rapid convergence to a user selection.

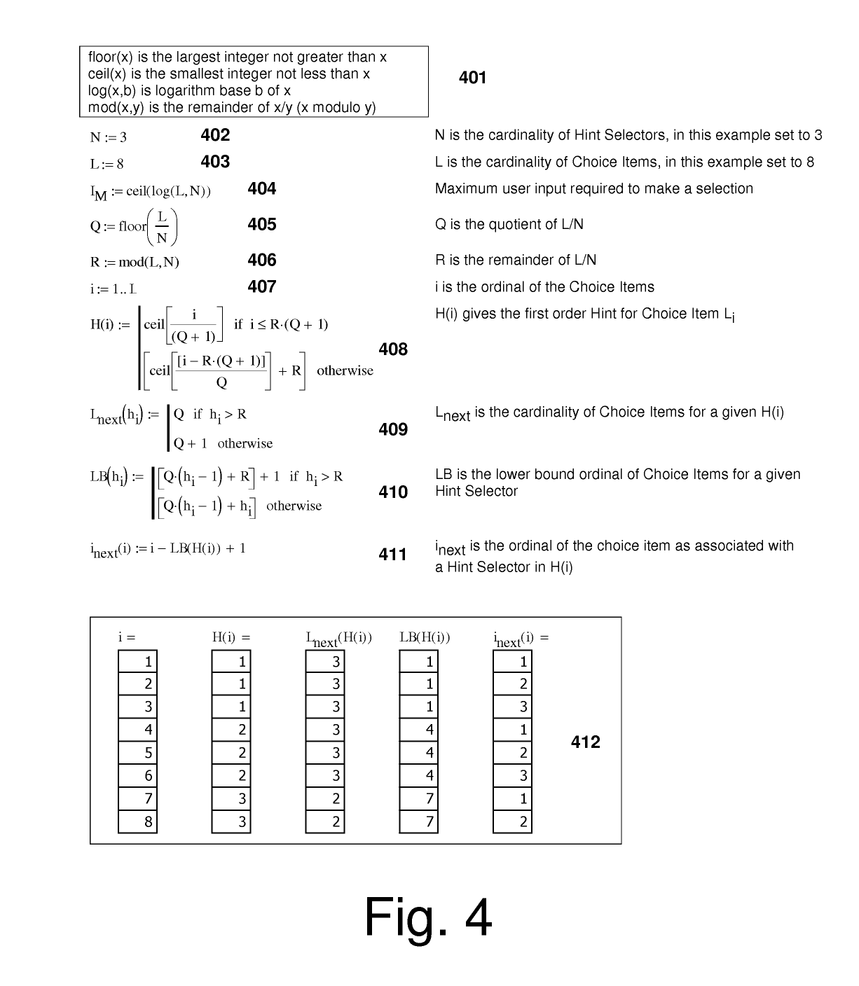

One such exemplary method of associating hint selectors to choice items which helps approach optimal minimum user input is shown in FIG. 4 (Note: figure references are displayed in bold to avoid confusion with the equations). Common mathematical functions are listed in 401. If N=the cardinality of hint selectors 402 and L=the cardinality of choice items 403 then even distribution of choice items with hint selectors results in the maximum elimination of undesired items per user input. This method of distribution results in the following maximum number of user input actuations to make a selection I_{M}=ceil(log(L,N)) 404. We can deterministically calculate the first order hint for a choice item as follows: define Q=floor(L/N)—this is the quotient of L/N 405. R=L modulo N 406—this is the remainder of L/N. If ‘i’ is the ordinal of an item in the choice items (407) then the first order hint of choice item ‘i’ is: H(i)=ceil(i/(Q+1)) if i<=R(Q+1) and ceil((i−R(Q+1))/Q)+R) otherwise 408. The reason this has two parts is that if there is a remainder R then the remainders have to be distributed equally between the hint selectors. The equation puts these R extra choice items one per hint selector starting with the first hint selector until they are gone. This may be easier to understand with a specific example. If we have 3 hint selectors (left, up, and right) and their ordinals 1, 2, and 3 respectively, and 8 choice items then: L=8, N=3, Q=2, R=2. With this simple example we see that the first two hint selectors will have 3 choice items associated with them and the last hint selector will only have 2. Plugging these numbers into H(i) we see the first order hint selector assignments as follows (for i=1,2, . . . 8) H(i) give 1,1,1,2,2,2,3,3 so choice items 1,2,3 will be displayed with a left arrow as their first hint, 4,5,6 the up arrow and 7,8 the right arrow, these results are shown in 412. The equations can be easily modified to put the extra remainder items with the ending hint selectors instead of the beginning.

The preceding exemplary method of associating hint selectors with choice items is only one of many possible methods and is presented to aid in understanding the invention not to limit the scope of the invention.

It is sometimes convenient to display additional (2^{nd} 3^{rd}, . . . ) order hint selectors instead of just the first order hint as described above. One exemplary method of doing this involves recursively calling H(i) utilizing the previous results to calculate the next order result. N typically stays fixed but subsequent calls to H(i) requires the cardinality of L for the next order calculation (Lₙₑₓₜ) and the next order ordinal of choice item i (iₙₑₓₜ). The next order L is given by the equation Lₙₑₓₜ(hᵢ)=Q if hᵢ>R and Q+1 otherwise 409 where hᵢ is the result of H(i). The next order ordinal of choice item i is given by iₙₑₓₜ(i)=i−LB(H(i))+1 411 where LB(x) is the lower bound ordinal of choice items that are associated with the given hint selector x. LB(hᵢ)=Q•(hᵢ−1)+R if hᵢ>R and Q•(hᵢ−1)+hᵢ otherwise 410. With the new values Lₙₑₓₜ and iₙₑₓₜ we utilize the original equation H(i) and calculate the next order hint selector assignment.

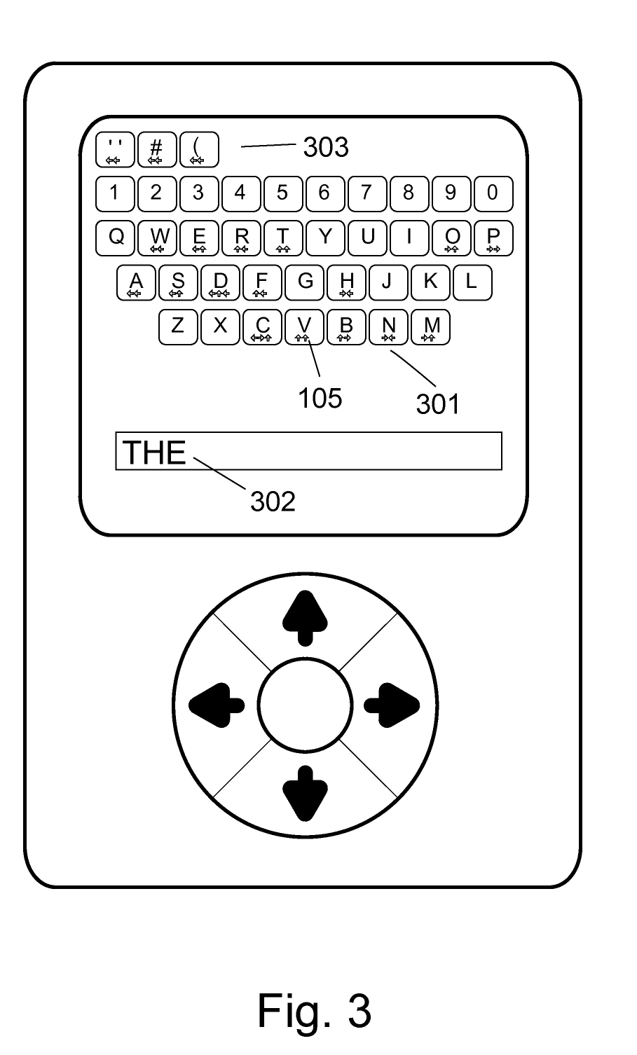

When presenting a list of choice items that is larger than can be conveniently displayed on the display it can be useful to create logical groupings of choice items that can be presented on the display to the user. One exemplary method can be seen in FIG. 3 in which grouping of textual choice items are presented based on the first non-common character. A virtual keyboard is displayed 301 where the next characters presented for user selection are displayed with hints 105. Characters that don't match the basic keyboard 301 are presented in a separate area 303. The characters that were already common to the group, or were previously selected by the user, are displayed in another area 302 as a reference for the user. When the cardinality of the subset of choice items drops below a value that can be displayed on the screen the final selection can be made from the list as shown in FIG. 1. There are many different ways to present the virtual keyboard 301 such as only displaying characters with hints assignments or changing the layout. It's also possible to group on non-textual choice items, the key is grouping in a manner that allows the user to understand the sequence e.g. a color picker where colors are grouped by spectrum and presented as a series of graphics spectrum groups, the user selects the group in which their desired color appears and that group is further subdivided until the groups only contain one color. The preceding two exemplary methods of grouping choice items are two of many possible methods and are presented to aid in understanding the invention not to limit the scope of the invention.

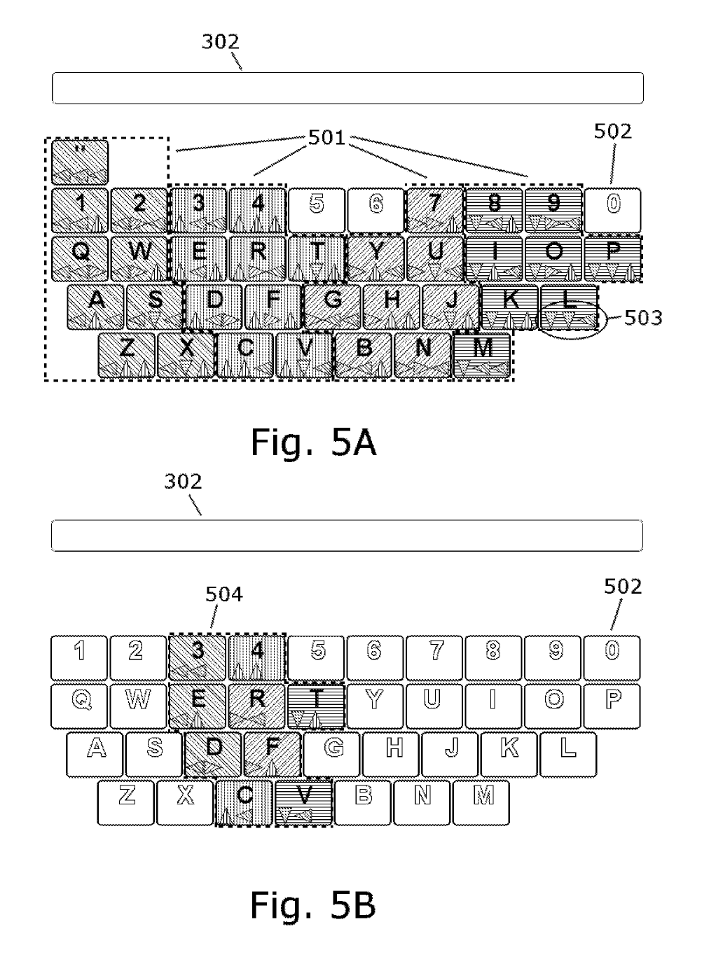

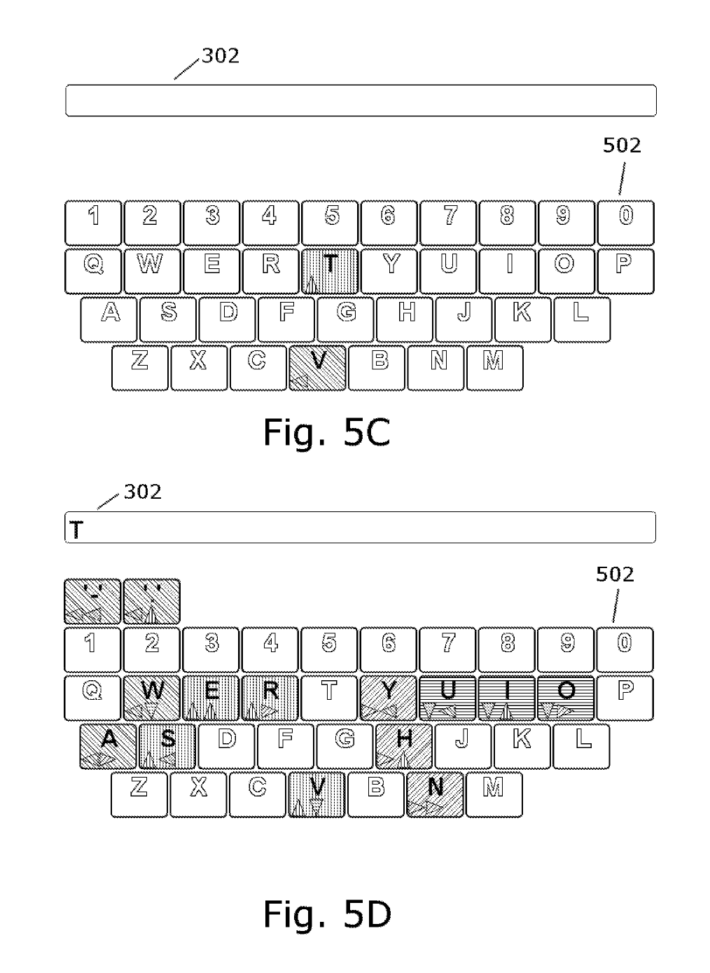

FIG. 5A, 5B, 5C, 5D shows a step by step example that expands on the previous virtual keyboard show in FIG. 3. A particular embodiment displaying a virtual keyboard when the list of choice items is textual and larger than can be presented on the display to the user wherein the choice items are grouped by their first non-common characters and these characters are utilized as the choice items. In this example starting in FIG. 5A there are no common characters yet selected and displayed in area 302. The characters that are utilized as our first set of choice items are displayed utilizing several possible visual enhancements: using colored backgrounds 501 (colors indicated by line patterns), to indicate which hint selector each choice item is associated with, arrows for first, second, and third order hint selectors, these hint selectors also shown with their associated color 503. It also demonstrates the possibility of visually grouping the choice items that are assigned to hint selectors to aid the user, 501 points to the 4 groups, outlined in a dashed line, where each group would become the next list of choice items if their associated hint selector is actuated. In this example choice items with no associated hint selector have no color 502. FIG. 5B shows how this example looks if the user actuates the input associated with the up hint selector. We see that the up group from 501 is now the only group 504 that is active all other groups have been eliminated with a single key actuation. Note that the remaining choice items in 504 are still grouped from left to right, those groups being 3, E, D are associated with the left hint selector, C,4 are associated with the up hint selector, R, F are associated with the right hint selector and V, T are associated with the down hint selector. FIG. 5C shows the next step if the user actuates the input associated with the down hint selector. The V and T choice items were the only keys associated with the down hint selector and are all that remain. Finally FIG. 5D shows how the choice items may look if the user actuates the input associated with the up hint selector. Since there is only one choice item associated with the up hint selector the choice item, which in this case is ‘T’, is submitted as the users selection and displayed in area 302. Now all the choice items that start with T are our current set of choice items and the letters after T are the first non common letters which we will use as the choice items to select the second character. Again, the colored backgrounds are grouped from left to right where choice items ‘-‘,’.’,A,W are associated with the left hint selector, S, E, R, V with up, Y, H, N with left, and U, I, O with down. Grouping and selecting characters in this manner will eventually winnow down the group of choice items to a size that can be displayed on the screen with hint selectors as previously shown in FIG. 1.

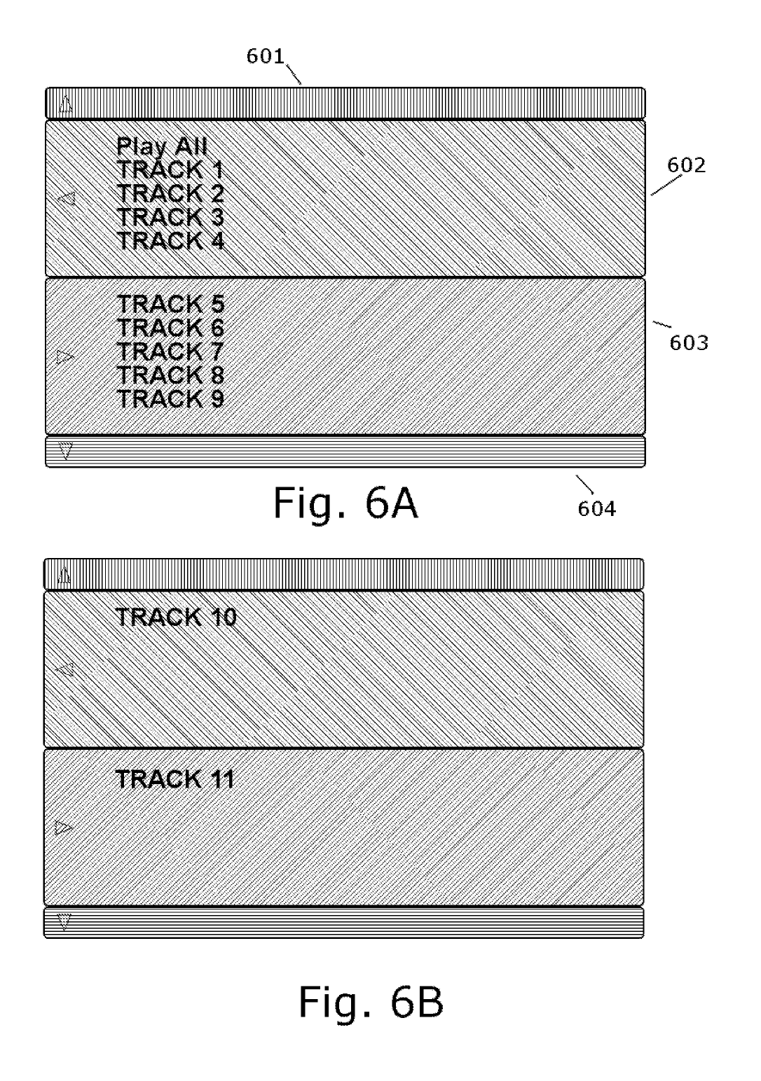

FIG. 6A shows an example of a particular embodiment that provides a scrollable list of choice items. Scroll up 601 is associated with the up hint selector, “Play All” and Tracks 1-4 are associated with the left hint selector 602, Tracks 5-9 are associated with the right hint selector 603, and scroll down 604 is associated with the down hint selector. FIG. 6B shows how the screen from 6A might look if the down hint selector were actuated. Actuating the left hint selector in 6A would present the user with Tracks 5 through 9 with associated hint selectors to further choose from the remaining 5 choice items, while actuating the left hint selector in FIG. 6B might submit the Track 11 choice item to the system as the user's selection.

Although the present invention for purpose of explanation has been described with reference to specific exemplary embodiments, it will be understood that the invention is not limited to the embodiments described herein. A person of ordinary skill in the art would understand that the present invention can be practiced with modifications and alternations to those embodiments or can be practiced in other embodiments within the spirit and scope of the appended claims.

Moreover, non-dependent acts may be performed in parallel. The embodiments were chosen and described in order to best explain the principles of the invention and its practical applications, to thereby enable others skilled in the art to best utilize the invention and various embodiments with various modifications as are suited to the particular use contemplated.

Furthermore, the use of the phrase “one embodiment” or “one exemplary method” throughout does not necessarily mean the same embodiment or method. Although these particular embodiments of the invention have been described, the invention should not be limited to these particular embodiments. Accordingly, the specification and drawings are to be regarded in an illustrative sense rather than a restrictive sense.

Unless specifically stated otherwise, it is to be appreciated that throughout the discussions utilizing terms such as “processing” or “computing” or “calculating” or “determining” or “displaying” or the like refer to the action and processes of a computer system or similar electronic computing device that manipulates and transforms data represented as physical (e.g. electronic) quantities within the computer systems registers and memories into other data similarly represented as physical quantities within the computer system.

The present invention can be implemented by an apparatus for performing the operations herein. This apparatus may be specially constructed for the required purposes or it may comprise a machine, such as a general-purpose computer selectively activated or reconfigured by a computer program (such as a collection of instructions for execution by a machine or processor for example) stored in the computer. Such a computer program may be stored in a computer readable storage medium, such as, but not limited to any type of disk including floppy disks, optical disks, magnetic optical disks, read-only memories, random access memories, EPROMS, EEPROMS, magnetic or optical cards or any type of media suitable for storing physical (e.g. electronic) constructions and each coupled to a computer system bus. Each of these media may be coupled to a computer system bus through use of an appropriate device for reading and or for writing the media.

What I claim as my invention is:

1. A method of providing functionality from a software application via an improved user interface the method comprising: providing, by computer, a plurality of selectable items, a plurality of inputs,
wherein utilizing at least 2 of the inputs as input selectors, each input selector associated with a graphic representation,
wherein utilizing at least 1 of the selectable items as choice items, each choice item associated with a graphical representation,
wherein the input selectors are associated with the choice items, assigning multiple choice items to input selectors when the cardinality of choice items exceeds the cardinality of input selectors, and the graphical representation of the choice items are displayed on a screen with the graphical representation of their associated input selector,
wherein receiving an indication of an actuation of an input selector, and there is a single choice item associated with the actuated input selector then the choice item is submitted for processing via the software application,
wherein receiving an indication of an actuation of an input selector, and there are multiple choice items associated with the actuated input selector then this group of choice items is used as the choice items and process of associating choice items to input selectors and receiving an indication of an actuation of an input selector is repeated until only a single choice item is associated with the actuated input selector.

2. The method of claim 1, wherein the choice items are textual and the choice items are grouped by the first non-common characters and these characters is used as the choice items.

3. The method of claim 1, wherein the graphic representation of the input selectors are calculated for subsequent order choice item selections and the graphical representation of the first order input selector and the graphical representation of the subsequent order input selectors are displayed on the screen with the associated first order choice item.

4. The method of claim 1, wherein after the actuation of an input selector the choice items are noted and the user is presented with an option to transition backward upon subsequent presentation of selected choice items.

5. The method of claim 1, wherein the choice items are a menu of commands to the device.

6. The method of claim 1, wherein the choice items are a list of media files which the device.

7. The method of claim 1, wherein the choice items are hypertext links.

8. A user selection system, comprising:
a user input device, said user input device including at least four inputs, said at least four inputs including a first input, a second input, a third input and a fourth input, said first input, said second input, said third input and said fourth input being oriented in a substantially diamond configuration with said first input in a top position, said second input in a left position, said third input in a bottom position and said fourth input in a right position, said user input device being configured for receipt of a user selection via activation of one of said first input, said second input, said third input or said fourth input;
a memory, said memory configured to store a program of instructions;
a processing unit operatively coupled to said memory; said processing unit configured to execute said program of instructions stored in said memory to produce a graphical user interface, said processing unit being operatively coupled to said user input device to receive said user selection from said user input device;
a display, said display configured to present said graphical user interface, said display communicatively coupled to said processing unit, wherein said graphical user interface includes a group of selectable items, wherein each selectable item of said group of selectable items includes at least one identifier, said at least one identifier being associated with at least one input of said user input device including at least four inputs, wherein after receipt of said user selection corresponding to at least one identifier, said processing unit is configured to at least one of execute a function of a selectable item associated with the at least one identifier or modify the group of selectable items by removing selectable items which are not associated with the at least one identifier.

9. The method of claim 8, wherein said selectable items are textual and said selectable items are grouped by the first non-common characters and these characters is used as said selectable items.

10. The method of claim 8, wherein one of said selectable items represents an undo operation, said selectable item representing an undo operation includes an identifier, said identifier being associated with one input of said user input device including at least four inputs.

11. The method of claim 8, wherein the hints are calculated for subsequent order choice item selections and presented to the user as a series of hint selector inputs required to converge on a specific choice item.

12. The method of claim 8, wherein at least one of said selectable items are a menu of commands to the device.

13. The method of claim 8, wherein at least one of the selectable items are a list of media files which the device can cause to process.

14. The method of claim 8, wherein at least one of the choice items are hypertext links.

15. The method of claim 8, wherein said display is part of a cell phone.

16. The method of claim 8, wherein said memory and said processing unit are part of a cable or satellite set top box.

17. The method of claim 8, wherein said memory and said processing unit are part of a digital video recorder.

18. The method of claim 8, wherein said memory and said processing unit are part of a portable multimedia player.

19. The method of claim 8, wherein said user input device is a remote control.
